(19) United States
(12) Patent Application Publication
(10) Pub. No.: US 2003/0121059 A1
(43) Pub. Date: Jun. 26, 2003

(54) Method and apparatus for providing a reminder message to display

(75) Inventor: Muralidharan Ramaswamy, Danbury, CT (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/029,097

(22) Filed: Dec. 21, 2001

(51) Int. Cl. H04H 1/00; H04H 7/00; G06F 3/00; H04N 5/445; G06F 13/00; H04N 7/173; H04N 7/16; H04M 1/00; H04B 1/38

(52) U.S. Cl. 725/141; 455/3.06; 455/556; 455/3.01; 725/133; 725/153

(57) ABSTRACT

A method and apparatus for causing a television to display a reminder message previously entered by a user and stored into a handheld device or another device having memory. The user uses a keyboard on the handheld device to enter reminder information into the handheld device, which may be a remote control electronic device. The entered reminder information is stored and transmitted at the appropriate time for display on the television which generates a visual text message signal superimposed on a portion of the television's normal programming.

### FIELD OF THE INVENTION

The present invention relates to providing a reminder message for display on a television display.

### BACKGROUND OF THE INVENTION

There are many television viewers who spend much of their day watching television. Such viewers typically spend a great proportion of their day at home, often alone, and use television as entertainment until the remainder of the family returns home and/or as a companion. These viewers often become completely engrossed viewing the television programs and forget scheduled events, appointments and other tasks. For example, elderly or sick television viewers may lose track of time watching a favorite classic movie and forget to take medicines at prescribed intervals and/or the exact dosage to take. Homemaker television viewers may similarly become so involved in a daytime television soap opera or game show that their children remain at school or day care centers waiting for a pick up. Other events that a television viewers may forget include appointments, dinner dates, parties, and viewing other television programs.

Although electronic devices independent of a television, including, for example, computers, personal digital assistants, etc., can be used to store and display reminders, if the reminder is displayed on those devices while the viewer is watching television, the user may easily not notice the reminder message or may simply ignore it, and thereby miss the scheduled event.

### SUMMARY OF THE INVENTION

The present invention is directed to a method and apparatus for causing a television to display a reminder message previously entered by a user and stored into a handheld device or another device having memory. The user uses a keyboard on the handheld device to enter reminder information into the handheld device, which may be a remote control electronic device. The entered reminder information is stored and transmitted at the appropriate time for display on the television which generates a visual text message signal superimposed on a portion of the television's normal programming, which may be a broadcast program or a prerecorded program such as a movie played on a VCR or DVD player.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference numerals delineate similar elements:

FIG. 1 depicts a television system in accordance with the present invention;

FIG. 2 depicts a block diagram of a handheld device of the television system of the present invention shown in FIG. 1;

FIG. 3 depicts a block diagram of a first embodiment of an adapter box in the television system of the present invention shown in FIG. 1;

FIG. 4 depicts a block diagram of a second embodiment of an adapter box in the television system of the present invention shown in FIG. 1;

FIG. 5 depicts a flow chart of one method for processing reminder information in accordance with the present invention; and

FIG. 6 depicts a flow chart of another method for processing reminder information in accordance with the present invention.

### DETAILED DESCRIPTION OF THE PRESENTLY PREFERRED EMBODIMENTS

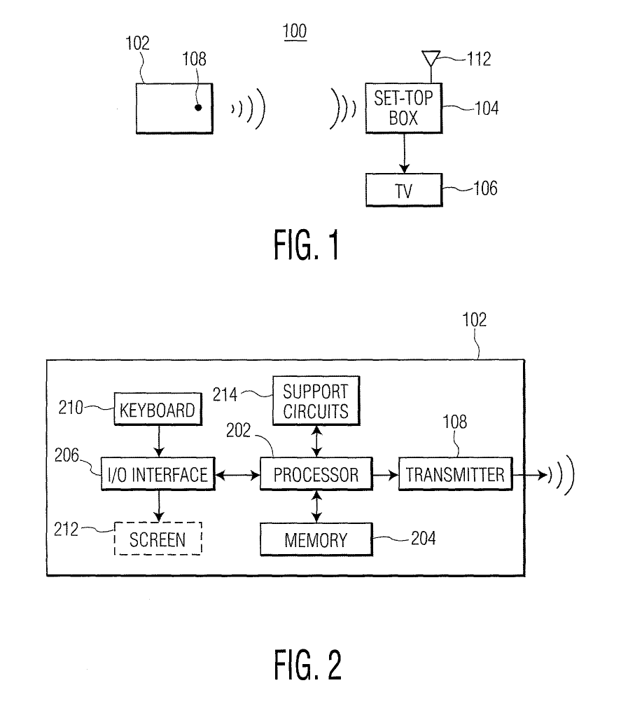

FIG. 1 depicts a television system 100 suitable for use with the present invention comprising a handheld device 102, a set top box 104, a television 106, and a television signal input 112. The handheld device 102 is capable of wirelessly transmitting signals through a transmitter 108, such as an antenna or an infrared transmitter, to the set top box 104 which receives the transmitted signals. Appropriate receiver components of the set top box 104 may alternatively be incorporated into the television 106. A preferred handheld device 102 is a remote control device with a keyboard with which a user may enter alpha numeric entries, such as the PRONTO device manufactured by U.S. Philips Corp. Other types of handheld devices, such as an appropriately configured mobile phone, personal digital assistant, or pager, may also be used. The television may be an analog television, a digital television (such as HDTV), a TV monitor, or a computer monitor used as a television display. The television signal input 112 can receive broadcast programming from a remote service provider through an antenna, satellite dish or cable input, or recorded local programming, such as movies, from a VCR or DVD player.

A block diagram of the handheld device 102 of the present invention is depicted in FIG. 2. The handheld device 102 comprises a processor 202, memory 204, an input/output (I/O) interface 206, a transmitter 108, a keyboard 210, a display screen 212, and support circuits 214. The keyboard 210 enables a user of the handheld device 102 to enter alpha numeric entries corresponding to reminder information. Reminder information includes the time to provide a reminder message for an event and details about the event.

The I/O interface 206 receives the reminder information entered by the user through the keyboard 210 and converts the inputted reminder information into a format suitable for processing by the processor 202. The I/O interface 206 also receives reminder data from the processor 202 and converts this data to a form suitable for display on the display screen 212. The display screen 212 is used to display to the user entries that the user is entering or has entered with the keyboard 210. Alternatively, the screen 212 on the handheld device 102 may be omitted, with the television 106 being used by the handheld device 102 to display reminder information as it is being entered or edited by the user or information that has been previously entered and stored in memory 204. Support circuits 214 facilitate the operation of the handheld device 102 and may include a clock, and an alarm.

The processor 202 coordinates the operation of the handheld device 102 including the entry of reminder information from the keyboard 210 and the transmission of the reminder information through the transmitter 108. The processor 202 also coordinates storage of converted reminder information from the I/O interface 206 into the memory 204 and retrieval of stored reminder information from the memory 204 at appropriate times in accordance with instructions of software programs stored in the memory 204. The transmitter 208 receives the reminder information from the processor 202 and transmits it wirelessly via the transmitter 108 to the set top box 104 or the television 106. Such wireless transmission may be in the form of an appropriately modulated infrared or radio frequency signal, for example. The set top box 104 is equipped to receive the signal from the handheld device 102.

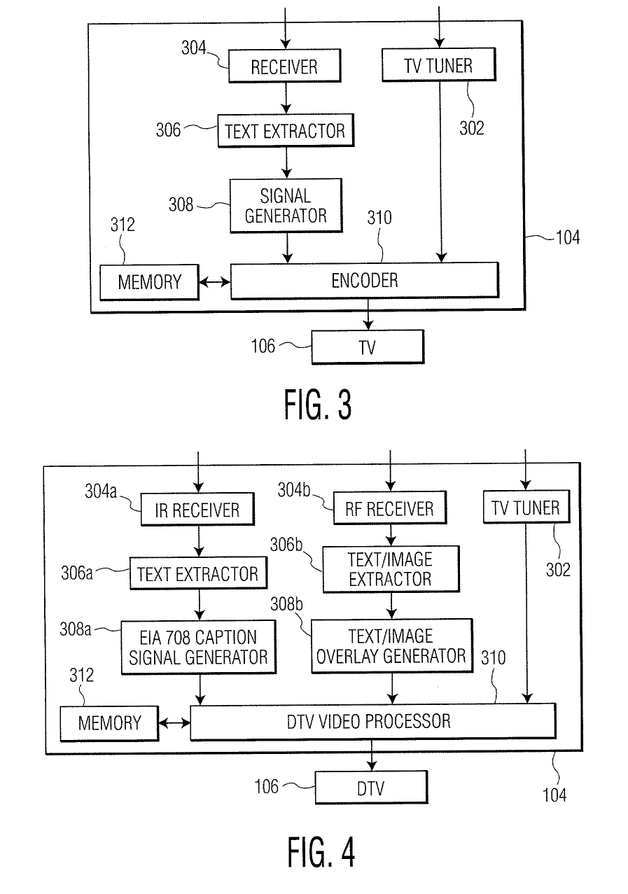

FIG. 3 depicts a block diagram of a first embodiment of the receiver portion of the television system 100 of the present invention shown in FIG. 1. In this embodiment, the television 106 is an analog television, for example, a NTSC television. The set top box 104 preferably comprises a television signal tuner 302, a receiver 304, a text extractor 306, a signal generator 308, and an encoder or processor 310. The tuner 302 receives and tunes onto a frequency associated with an analog television channel to receive a television signal from a television signal input 112. The television signal includes video and audio signal portions. The tuner 302 demodulates the received television signal and provides its output to the encoder 310. The encoder or processor 310 converts the input television signal, if necessary, into a descrambled signal for presentation by the television. Typically, the received television signal is scrambled so that a user/viewer is required to subscribe to television services to obtain a descrambled signal. The audio portion of the television signal is typically not scrambled. The receiver 304 receives the signal from the handheld device 102 and demodulates the received signal. The text extractor 306 extracts any text information in the signal from the handheld device 102 and passes this text signal to the signal generator 308 which generates a closed caption signal corresponding to the text message. The closed caption signal is fed to the encoder or processor 310 which combines it with the descrambled television signal for transmission to the television 106 so that the text image is displayed, superimposed on a portion of the television program image. In a preferred embodiment, the closed caption signal corresponding to the text message is inserted into line 21 of the vertical blanking interval (VBI) of the television video signal. Although the reminder information may be stored in memory 204 of the handheld device 102, alternatively, the reminder information may be stored in memory 312 present in the set top box 104. Set top memory 312 is also used to store any operating instructions for encoder or processor 310. Alternative the reminder information may be stored in a memory module in the television 106 or in another connected device, such as a personal computer.

FIG. 4 depicts a block diagram of a second embodiment of the receiver portion of the television system 100 of the present invention shown in FIG. 1. In this embodiment, the television 106 is a digital television (DTV), for example, a high definition television (HDTV). The set top box 104 comprises a television tuner 302, an IR receiver 304a, text extractor 306a, a closed caption signal generator 308a, a radio frequency (RF) receiver 304b, a text/image extractor 306b, an text/image overlay generator 308b, a DTV video processor 310 and an memory module 312. In this embodiment, the set top box 104 has both an IR receiver and an RF receiver and parallel components to process the signal received from the handheld device 102 for processing by the video processor 310 and display on the television 106. The components of the set top box 104 may, alternatively, be disposed in the television 106. A signal from the handheld device 102 would typically be transmitted as an IR signal if it contains only text data, while it would be transmitted as RF signal if, in addition to text, it also contained one or more images. Such images may be stored in the memory 204 of the handheld device 102 and selected by the user to supplement and/or enhance any text in the reminder message. The closed caption signal generator 308a preferably generates a closed caption signal in accordance with EIA-708, the digital television closed caption standard.

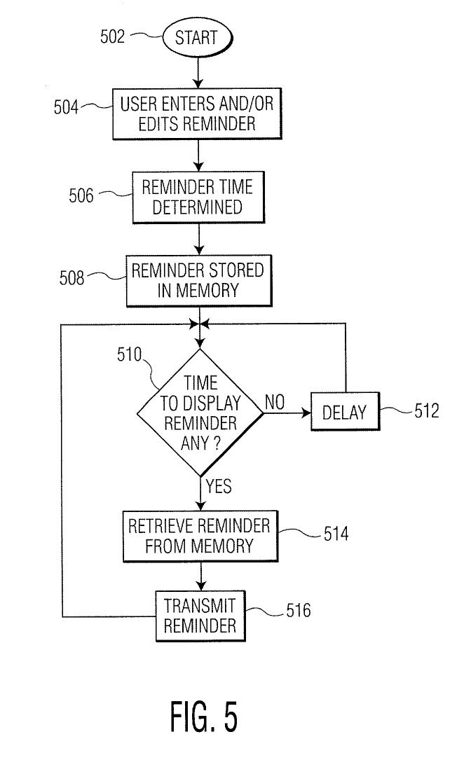

FIG. 5 depicts a flow chart of a method for processing reminder information in accordance with the present invention. Although the method is described with respect to reminders for one event, the method likewise applies to reminders for multiple events. In this case, the reminders for multiple events may be processed in a queue or a time-ordered format. Alternatively, the method is independently applied for reminders of each event.

Initially, the handheld device 102 is turned on, step 502. A user uses the keyboard 210 to enter reminder information associated with an event into the handheld device 102, step 504. Alternatively, or in addition, the user can delete or edit previously entered reminder information, such as by changing the text or graphics of the reminder or by changing the time that the reminder is to be displayed.

Once a reminder entry has been entered by the user, the handheld device 102 determines the appropriate time to transmit a reminder signal for display on the television, step 506. The time of the reminder may be obtained from the information entered by the user or determined as a predetermined time prior to the event. The reminder time may be, for example, 0 minutes before the scheduled event where no advance warning is required, such as a reminder to take a prescribed medication. The reminder time may be 5 minutes for a reminder to watch a desired television program. The reminder may be 60 minutes for a reminder for an appointment scheduled remotely from the television, such as a luncheon appointment at a restaurant. Alternatively, the reminder may be set so that it repeats periodically for a limited time, such as every 5 minutes after an initial starting time up to the time of the event, or periodically for an unlimited time, such as once every three hours or once a day, which would be useful as a reminder to take prescription drugs. The entered reminder information is stored in memory 204 of the handheld device 102 or in another memory module, such as memory 312 of set top box 104, step 508.

The stored reminders are then processed by the handheld device 102 to determine whether it is time to display a reminder to the user, step 510. Alternatively, the processor 310 of the set top box 104 or another connected processor with an appropriate memory module may process the reminders. If it is not yet time to display a reminder, checking of reminder information is delayed, step 512, a predetermined period of time, such as, for example, five minutes, at which time reminder entries are checked again to determine if it is time to display a reminder message. When it is time to display a reminder message, the processor 202 (or 310) retrieves the appropriate reminder entry from the memory 204, step 514, and transmits a reminder signal for display on the television, step 516. The reminder signal is transmitted by transmitter 108 as an IR and/or RF signal to the set top box 104. The handheld device then continues to ascertain whether additional reminder entries are appropriate for display, step 510. Once a reminder has been transmitted for display on the television, the reminder may be automatically deleted from memory.

If the reminder entries are stored in the handheld device, referring again to FIGS. 3 and 4, when the set top box 104 receives the reminder information signal through its receiver 304, 304a, 304b, the extractor 306, 306a, 306b extracts text and/or graphics information from the signal, and the signal generator 308, 308a, 308b generates an appropriate signal to the encoder 310. The received reminder information is then displayed on the television 106 superimposed on the television signal received from the TV tuner 302. If the signal generated by the signal generator 308, 308a, 308b includes only text, the texts may appear on the television display as, or similar to, a closed caption message. If the signal generated by the signal generator 308, 308a, 308b also or only includes graphics, the graphics are displayed superimposed on a portion of the television programming, such as proximate an edge of the screen.

To edit or delete a previously stored reminder entry, an appropriate key is depressed on the keyboard of the keyboard 210 of the handheld device 102 to cause the screen 212 on the handheld device 102 or the television 106 to display the entry to be modified. The particular entry can be selected from among other stored reminder entries using the keyboard, and appropriate keyboard entries are used to edit or delete the desired entry.

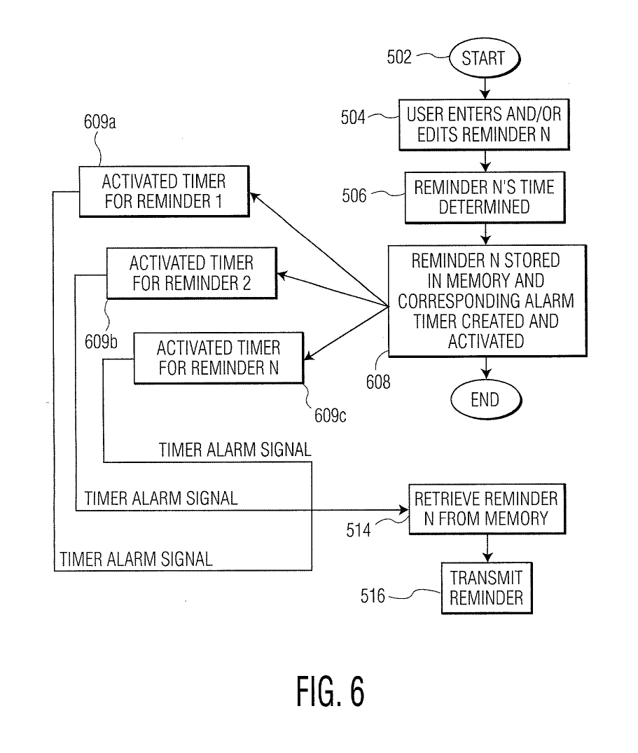

FIG. 6 depicts a flow chart of another method for processing reminder information in accordance with the present invention. In this method, each reminder has its own starting or activating alarm. The method is identical to that shown in FIG. 5 through step 506 in which the reminder time for the entered message is determined. In step 608, the reminder is stored in memory, and a corresponding alarm timer is created and activated, as shown in boxes 609A, 609b, and 609c, which correspond to three separate, stored reminders. When the alarm timer for a message expires, a timer alarm signal, identifying the associated reminder, is transmitted, the appropriate reminder is retrieved from memory, step 514, and the reminder is displayed, step 516. In this embodiment, the program is not constantly checking for reminder display times, thereby saving processing resources and energy. The steps of entering reminder information is a parallel process separate from the steps of retrieving stored reminder messages and generating the messages for display to the user. As a result, it is easier to enter additional reminder entries.

Thus, while there have been shown and described and pointed out fundamental novel features of the present invention as applied to preferred embodiments thereof, it will be understood that various omissions and substitutions and changes in the form and details of the devices described and illustrated, and in their operation, and of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. An apparatus for providing a reminder message to a display comprising:
a handheld device comprising an input device for entering a reminder message and a transmitter for wirelessly transmitting a signal corresponding to the reminder message, the reminder message comprising reminder information and a time that the reminder information is to be displayed to a user;
a memory device for storing reminder messages;
a first data processor operatively connected to said memory device for retrieving reminder messages from said memory device at the time selected for display of the reminder information and for processing the reminder message to generate a display signal for each retrieved reminder message, the display signal being capable to cause a message corresponding to the respective reminder message to be displayed on a display;
a second processor suitable for receiving an audio/video signal and for processing the received audio/video signal for presentation on a television display, and for receiving the display signal from said first data processor and for causing the message corresponding to a retrieved reminder message to be displayed on the television display so that it is superimposed on at least a portion of the audio/video signal presented on the television display, the reminder message being displayed on the television display at the time selected for display of the reminder information.

2. The apparatus of claim 1, wherein said memory device for storing reminder messages and said first data processor reside in said handheld device.

3. The apparatus of claim 1, wherein said memory device for storing reminder messages resides in a set top box.

4. The apparatus of claim 1, wherein the message corresponding to a retrieved reminder message is transmitted to and displayed on the television display as text in a closed caption message.

5. The apparatus of claim 1, wherein the handheld device comprises a keyboard for entering alpha/numeric data.

6. The apparatus of claim 1, further comprising means for allowing stored reminder messages to be displayed on a display for editing of the reminder messages.

7. The apparatus of claim 5, further comprising means for allowing stored reminder messages to be displayed on a display for editing of the reminder messages.

8. The apparatus of claim 7, wherein said handheld device further comprises a display, and means for allowing a user to view the alpha/numeric data as the user enters it with said keyboard.

9. The apparatus of claim 8, wherein stored reminder messages are capable of being displayed on said display of said handheld device for editing of the reminder messages.

10. The apparatus of claim 6, wherein stored reminder messages are capable of being displayed on the television display for editing of the reminder messages.

11. The apparatus of claim 1, wherein a reminder message comprising text and an image is capable of being stored in said memory device for storing reminder messages, and a reminder message comprising text and an image is capable of being retrieved and displayed on the television display.

12. An method for providing a reminder message to a display comprising:
entering a reminder message on a handheld device, the reminder message comprising reminder information and a time that the reminder information is to be displayed to a user;
wirelessly transmitting a signal corresponding to the reminder message;
storing reminder messages in a memory device;
receiving the transmitted signal corresponding to the reminder message;
retrieving reminder messages from said memory device at the time selected for display of the reminder information;
processing the reminder message to generate a display signal for each retrieved reminder message, the display signal being capable to cause a message corresponding to the respective reminder message to be displayed on a display;
receiving an audio/video signal;
processing the received audio/video signal for presentation on a television display;
receiving the display signal;
causing the message corresponding to a retrieved reminder message to be displayed on the television display so that it is superimposed on at least a portion of the audio/video signal presented on the television display, the reminder message being displayed on the television display at the time selected for display of the reminder information.

13. The method of claim 12, wherein reminder messages are stored in a memory device in said handheld device.

14. The method of claim 12, wherein reminder messages are stored in a memory device in a set top box.

15. The method of claim 12, wherein the message corresponding to a retrieved reminder message is transmitted to and displayed on the television display as text in a closed caption message.

16. The method of claim 12, wherein stored reminder messages are capable of being displayed on a display for editing of the reminder messages.

17. The method of claim 12, wherein stored reminder messages are capable of being displayed on a display of the handheld device upon entry of the reminder messages.

18. The method of claim 12, wherein stored reminder messages are capable of being displayed for editing of the reminder messages on a display of the handheld device.

19. The method of claim 12, wherein stored reminder messages are capable of being displayed on the television display for editing of the reminder messages.

20. The method of claim 12, wherein a reminder message comprising text and an image is capable of being stored in said memory device for storing reminder messages, and a reminder message comprising text and an image is capable of being retrieved and displayed on the television display.
